(19) United States
(12) Patent Application Publication
(10) Pub. No.: US 2016/0210353 A1
(43) Pub. Date: Jul. 21, 2016

(54) DATA LOOKUP AND OPERATOR FOR EXCLUDING UNWANTED SPEECH SEARCH RESULTS

(71) Applicant: Avaya Inc., Basking Ridge, NJ (US)

(72) Inventors: Wendy J. Holmes, Worcestershire (GB); David Skiba, Golden, CO (US)

(21) Appl. No.: 14/600,268

(22) Filed: Jan. 20, 2015

(51) Int. Cl. G06F 17/30; G10L 15/08

(52) U.S. Cl. CPC G06F 17/30681; G10L 15/08; G06F 17/30864

(57) ABSTRACT

A method, system, and phonetic search engine are described that enable phonetic searches to have increased relevancy to the searcher. Specifically, phonetic searches on a database containing phonetically-searchable content can have one or more phonetically-confusable terms excluded from search results, thereby leaving search results that more faithfully reflect the search terms used during the phonetic search of the database.

### FIELD OF THE DISCLOSURE

The present disclosure is generally directed toward searching databases and more particularly toward phonetic speech searches.

### BACKGROUND

Phonetic speech search involves searching a database containing audio records for words and phrases by matching to a model of the expected possible sound patterns of the search term. This technique contrasts with speech-to-text (STT)-based approaches that search the output of a large-vocabulary speech recognizer. An advantage of the phonetic search approach is that the phonetic search approach is not constrained by vocabulary or recognition errors of any STT system. However, phonetic searching can suffer from false matches on similar-sounding but unwanted phrases. For example, searching for the word “contract” in speech that contains the word “contact” is likely to give false matches. If there is a large amount of audio containing similar-sounding but unwanted phrases, the extent of these false matches can lead to poor search results.

One way of addressing this problem is to try to specify sufficiently long search phrases to neutralize the effect of confusable words. For example, a search for “cancel my contract” may not give any false hits on “contact” if the word “contact” is not preceded by “cancel my.” Facilities for manually filtering and tagging results may also be offered. Unfortunately, these solutions are cumbersome and can result in certain relevant audio records not being returned because they do not exactly match the longer search phrase.

Accordingly, a need exists for an improved phonetic speech searching solution that avoids false matching problems, but also utilizes simple search strategies.

### SUMMARY

It is, therefore, one aspect of the present disclosure to provide a phonetic search solution that overcomes the above-mentioned problems. Embodiments of the present disclosure address the problem of false matches on similar-sounding phrases by utilizing the fact that the alternative similar-sounding phrase will, in general, match better to the region of audio in question. One aspect of the present disclosure is to allow the user of the speech search system to explicitly exclude any regions of audio that match better to known unwanted terms. For example, a phonetic search for “contact BUT NOT contract” would search for matches to the word “contact” but exclude any matches for which the same region of audio matched better to the alternative term “contract”.

Embodiments of the present disclosure operate by conducting searches for one or more competing/similarly sounding terms as well as a search for the term of interest. For each hit on the term of interest, the hit is removed if there are any higher-confidence matches on the competing terms that are on the same or substantially overlapping region of audio.

In one embodiment, the user would specify the competing terms. However, it may also be possible to generate a set of confusable terms automatically: for example by selecting phonetically-confusable words from a pronunciation dictionary.

In the automatic generation of confusable terms, the system may generate a cluster or define a predetermined phonetic distance from the term of interest. Specifically, depending upon a user's tolerance for false positive hits, the phonetic distance can be varied to include more or less phonetically-confusable terms. If the user prefers potentially excluding some passages of interest to avoid too much noise (e.g., false positive search results), the phonetic distance may be increased, thereby including more phonetically-confusable words in the “BUT NOT” operator. On the other hand, if the user prefers over inclusion at the expense of some false positive hits, the phonetic distance may be decreased, thereby decreasing the number of phonetically-confusable words in the “BUT NOT” operator. A hybrid approach could also be used whereby the system automatically generates a set of phonetically-confusable terms and then allows the user to select whether or not to include those terms in the “BUT NOT” operator.

Embodiments of the present disclosure also have increased value due to the variety of deployment options. In one embodiment, the searching solution described herein can be implemented into a speech search provider (e.g., as a built-in feature of an audio database or a search engine for an audio database). Alternatively or additional, a portion of the searching solution (e.g., automatic term expansion with BUT NOT operators) can be implemented as a pre-processing step to other speech search providers.

The proposed solution acts to remove unwanted search results and so improve overall accuracy of the search system. The idea differs from the AND NOT Boolean operator that is sometimes used in search systems in that the proposed solution explicitly filters out competing matches on the same region of audio based on relative confidence scores. This is in contrast to the more standard AND NOT which, in the context of audio search, would look for audio containing occurrences of one term that did not also contain hits on another term. In the case of similar-sounding phrases or phrase portions, it is likely that all audio containing hits on the one term would also contain hits on the other term without the explicit filtering based on time and confidence information that is the subject of the current invention.

Accordingly, it is one aspect of the present disclosure to facilitate the exclusion of search hits based on a comparison of scores for competing similar search terms on the same region of audio as well as the automatic identification of phonetically-confusable words for inclusion in the “BUT NOT” operator to reduce search results and increase search accuracy.

In some embodiments, a phonetic search engine is provided that generally comprises:

a requestor interface configured to receive one or more search terms for a phonetic search to be performed on a database containing phonetically-searchable content;

a database operator module configured to format a database query that includes at least some of the one or more search terms received at the requestor interface; and

a phonetic analysis module configured to perform at least one of the following to exclude phonetically-confusable terms associated with the one or more search terms from search results provided to a user: (i) modify the database query prior to the database query being sent to the database and (ii) modify original search results received from the database to obtain reduced search results.

The term “distance” or “phonetic distance” as used herein can correspond to any type of distance determination or calculation. In particular, a phonetic distance may correspond or represent the “goodness of match” between a search term and a search result. As an example, a goodness of match or phonetic distance may actually be modeled as a probability, where it is common to use negative log probabilities and refer to these values as “distances.” Thus, anything representing “goodness of match” may be as a replaceable term for phonetic distance. As some non-limiting examples, goodness of match may be modeled as distance (where lower is closer and a better match), probability (where higher is closer and a better match), or any other measure that can be used to evaluate similarity.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The term “computer-readable medium” as used herein refers to any tangible storage that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, or any other medium from which a computer can read. When the computer-readable media is configured as a database, it is to be understood that the database may be a graph database as described herein. Accordingly, the disclosure is considered to include a tangible storage medium and prior art-recognized equivalents and successor media, in which the software implementations of the present disclosure are stored.

The terms “determine”, “calculate”, and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the disclosure is described in terms of exemplary embodiments, it should be appreciated that individual aspects of the disclosure can be separately claimed.

### BRIEF DESCRIPTION OF THE DRAWINGS

The present disclosure is described in conjunction with the appended figures:

FIG. 1 is block diagram depicting a communication system in accordance with embodiments of the present disclosure;

FIG. 2 is a block diagram depicting a system for recording and storing audio from a communication session in accordance with embodiments of the present disclosure;

FIG. 3 is a block diagram depicting a system for searching a database in accordance with embodiments of the present disclosure;

FIG. 4 is a block diagram depicting details of a search engine in accordance with embodiments of the present disclosure;

FIG. 5A depicts one possible scheme for automatically refining a phonetic search in accordance with embodiments of the present disclosure;

FIG. 5B depicts another possible scheme for automatically refining a phonetic search in accordance with embodiments of the present disclosure;

FIG. 6 is a block diagram depicting a series of refined search results in accordance with embodiments of the present disclosure;

FIG. 7 is a flow diagram depicting a method for performing a phonetic search in accordance with embodiments of the present disclosure;

FIG. 8 is a flow diagram depicting a method for refining a phonetic search in accordance with embodiments of the present disclosure; and

FIG. 9 is a flow diagram depicting a method for modifying a search query prior to sending the search query to a database in accordance with embodiments of the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the embodiments. It being understood that various changes may be made in the function and arrangement of elements without departing from the spirit and scope of the appended claims.

It should be appreciated that embodiments of the present disclosure can be utilized in numerous environments where it is desirable to search databases for, among other things, audio/audible content. The audio/audible content may include pure audio files or clips, video files or clips, or any other data structure that has content therein that is searchable phonetically. While embodiments of the present disclosure will be described in connection with storing audio content from a communication session between two or more session participants (e.g., two or more humans, one human and one or more automated participants, one or more humans and one automated participant, a conference, a broadcast, voicemails, etc.), it should be appreciated that embodiments of the present disclosure are not so limited. Indeed, some embodiments described herein can be applied to searching audio/audible content from something other than a communication session. For instance, embodiments of the present disclosure can be applied to searching music libraries/databases, video libraries/databases (e.g., the audio content thereof), searching within an audio file (e.g., WAV files, AIFF files, MP3 files, etc.), searching within a video file (e.g., CCIR 601, MPEG-4, MPEG-2, MPEG-1, H.261, H.263, H.264, etc.), and the like.

Furthermore, while the illustrative embodiments herein show the various components of a system collocated, it is to be appreciated that the various components of the system can be located at distant portions of a distributed network, such as a communication network and/or the Internet, or within a dedicated secure, unsecured, and/or encrypted system. Thus, it should be appreciated that the components of the system can be combined into one or more devices, such as an enterprise server or collocated on a particular node of a distributed network, such as an analog and/or digital communication network. As will be appreciated from the following description, and for reasons of computational efficiency, the components of the system can be arranged at any location within a distributed network without affecting the operation of the system. For example, the various components can be located in a local server, at one or more users' premises, or some combination thereof.

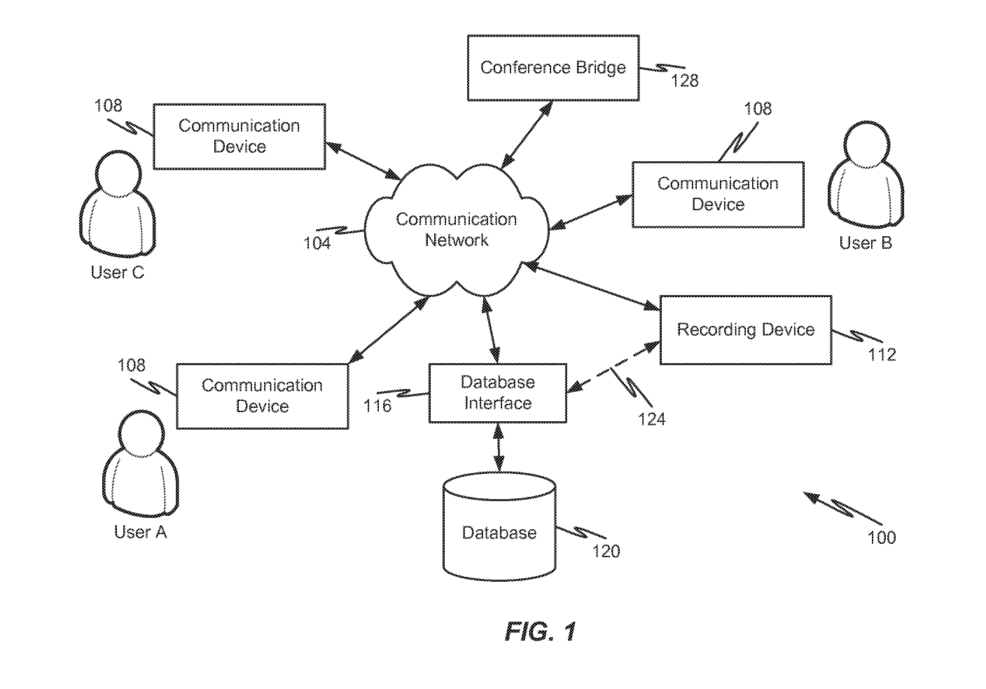

With reference initially to FIG. 1, an illustrative system 100 in which audio content is created and stored in a database 120 will be described in accordance with at least some embodiments of the present disclosure. The system 100 is shown to include a communication network 104, multiple communication devices 108 (operated by one or more users), a recording device 112, a database interface 116, a database 120, and a conference bridge 128.

In accordance with at least some embodiments of the present disclosure, the communication network 104 may comprise any type of known communication medium or collection of communication media and may use any type of protocols to transport messages between endpoints. The communication network 104 may include wired and/or wireless communication technologies. The Internet is an example of the communication network 104 that constitutes and Internet Protocol (IP) network consisting of many computers, computing networks, and other communication devices located all over the world, which are connected through many telephone systems and other means. Other examples of the communication network 104 include, without limitation, a standard Plain Old Telephone System (POTS), an Integrated Services Digital Network (ISDN), the Public Switched Telephone Network (PSTN), a LAN, a WAN, a Session Initiation Protocol (SIP) network, a Voice over IP (VoIP) network, a cellular network, an enterprise network, a contact center, and any other type of packet-switched or circuit-switched network known in the art. In addition, it can be appreciated that the communication network 104 need not be limited to any one network type, and instead may be comprised of a number of different networks and/or network types. Moreover, the communication network 104 may comprise a number of different communication media such as coaxial cable, copper cable/wire, fiber-optic cable, antennas for transmitting/receiving wireless messages, and combinations thereof.

In some embodiments, a communication device 108 may include a personal communication device or a shared communication device (e.g., a conference phone). Examples of suitable communication devices 108 include, without limitation, a telephone, a softphone, a cellular phone, a multi-speaker communication device (e.g., a conference phone), a video phone, a PC, a laptop, a tablet, a PDA, a smartphone, a thin client, or the like. The communication devices 108 may be pure consumers of audio/video (e.g., having a speaker only and/or having a screen only), pure producers of audio/video (e.g., having a microphone and/or camera only), or consumers and producers of audio/video. It should be appreciated that a communication device 108 may be configured to support single or multi-user interactions with other network-connected devices within an enterprise communication network and/or across multiple communication networks (e.g., across Session Border Controllers (SBCs)).

The recording device 112 may correspond to one or more network-connected resources that are capable of recording media exchanged during a communication session between two or more communication devices 108 or between a communication device 108 and an automated resource (e.g., voicemail, Interactive Voice Response (IVR) system, etc.). The recording device 112 may be inserted in a media path between the communication devices 108 operated by the communication session participants or the recording device 112 may receive a copy of media exchanged between communication devices 108 during a communication session. As a non-limiting example, the recording device 112 may be implemented as a call-recording application that is inserted during call set-up and inserted as a sequenced application (e.g., a Back-to-Back User Agent (B2BUA)) into the call vector. Situating the recording device 112 in such a way enables the recording device 112 to capture the media exchanged during a communication session.

As shown in FIG. 1, the recording device 112 may then interact with the database interface 116 to have the recorded content of the communication session stored in the database 120. This interaction may be via the communication network 104 or directly through a direct connection 124. In some embodiments, the recording device 112 and database interface 116 may be implemented in a common server, thereby obviating the need for network-based connections.

In embodiments where the recorded audio/video corresponds to content from a broadcast or from a dedicated recording session (e.g., a studio recording of an album track), the recording device may 112 may correspond to a purpose-built device that records content received from a speaker and/or camera and then formats the content (e.g., compresses, encodes, etc.) for storage in the database 120. It should be appreciated that the recorded content may be stored using lossy or lossless encoding techniques and any type of storage format may be used for storing the content within the database 120. Furthermore, the content may be indexed for easier searching and/or retrieval. Such indexing may be performed prior to storage or post storage in the database 120. The indexing may be stored at the database interface 116 or with the content in the database 120. Indexing engines are well known in the database and searching arts and will not be described in further detail herein. Although not depicted, it should be appreciated that an indexing engine may be implemented within the database interface 116 or at a separate server.

The database 120 and database interface 116 may correspond to any type of known or yet to be developed type of database and interface. Said another way, the construction of the database and its interface is not intended to be limited by embodiments of the present disclosure. Suitable non-limiting examples of databases 120 that may be used to store audio/video content and/or any other content that is phonetically-searchable include a hierarchical database, a graph database, a relational database, a network database, an object-oriented database, or the like. The database interface 116 may utilize a language or format that is operable to extract useful information from the database 120. Examples of languages that may be used by the database interface 116 include, without limitation, SQL, noSQL, NewSQL, and/or any other type of Database Management System (DBMS) known in the art. The database interface 116 is intended to facilitate interactions between the database 120 and other network devices (e.g., communication devices 108, recording device 112, conference bridge 128, etc.). The database interface 116 may be implemented as one or many servers, depending upon the size and complexity of the database 120.

The conference bridge 128 may correspond to a device (e.g., server) or collection of devices that enable media mixing and distribution during a communication session between two or more and usually three or more session participants. In some embodiments, the conference bridge 128 may include a media mixer and logic for distributing the mixed media among the conference participants. The conference bridge 128 may even provide a fully-mixed version of the conference to the recording device 112 for recording and storage in the database 120. Alternatively or additionally, the recording device 112 may be included as a conference participant in a communication session and may, therefore, connect to the conference bridge 128 like other communication devices 108.

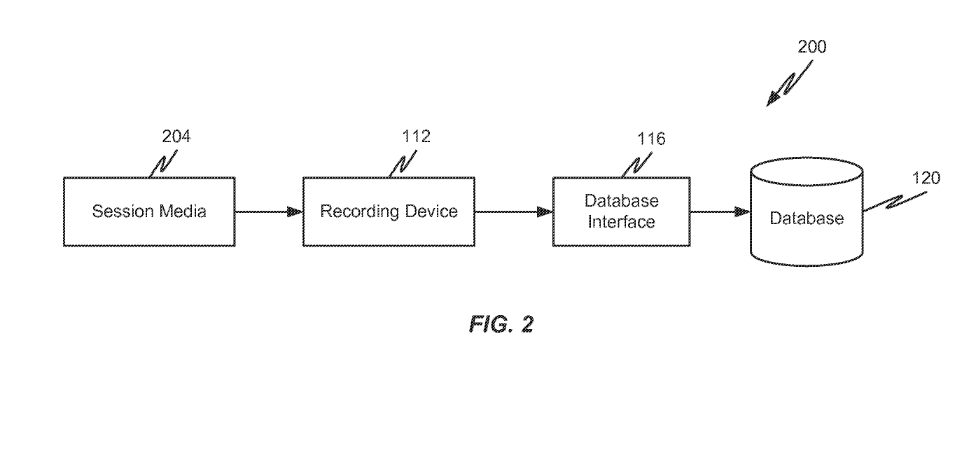

With reference now to FIG. 2, additional details of a system 200 for capturing and storing audio/audible content will be described in accordance with at least some embodiments of the present disclosure. The system 200 illustrates the interconnection between the recording device 112, database interface 116, and database 120. It should be appreciated that the system 200 is not necessarily limited to single instances of any component. Indeed, the system 200 may include multiple databases 120, multiple database interfaces 116, and/or multiple recording devices 112. The multiple devices may be partitioned, highly-scalable, or configured for high-availability (e.g., with back-up devices). The simple illustration of the system 200 and its components is intended to provide an easy-to-understand description of the operation of the system 200 components.

In some embodiments, a communication session may be established between two or more communication devices 108. The communication session may include session media 204 in the form of audio packets, video packets, analog audio, analog video, compressed audio, compressed video, encoded audio, encoded video, etc. that is transmitted from one communication device 108 to another or between a communication device 108 and the conference bridge 128. The session media 204 may be received at the recording device 112 and formatted for transmission to the database interface 116. In some embodiments, the recording device 112 may simply encode and/or compress the session media 204 for efficient storage in the database 120. In more sophisticated systems 200, the recording device 204 may further perform a first analysis of the session media 204 to create metadata or tags for the session media 204 before it is recorded in the database 120. For instance, the recording device 112 may create metadata describing the time at which the session media 204 is received, an identification of the session participants, a descriptor of the session type (e.g., two participant session, three or more participant session, conference, broadcast, etc.). In some embodiments, the recording device 112 may even perform a phonetic and/or phoneme analysis of the session media 204. The results of such an analysis may be stored with the session media as metadata or it may be converted to text that is searchable at a later time. It may even be possible for the recording device 112 to perform a speech-to-text conversion of some or all of the session media 204 prior to storing the session media in the database 120.

At some point during or after storage of the session media (or any audio/audible media), the recording device 112 or some other indexing engine can perform an indexing of the database 120 and the media stored thereon. This indexing engine can then be an initial point of reference when searching the database 120 for stored content.

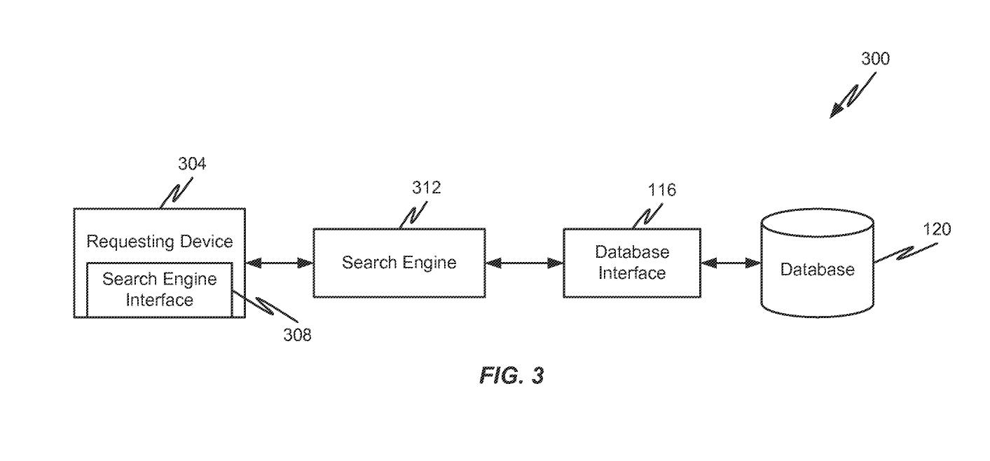

With reference now to FIG. 3, details of a system 300 for retrieving content or searching the database 120 will be described in accordance with at least some embodiments of the present disclosure. The system 300 again includes the database 120 and database interface 116. The system 300 is also shown to include a requesting device 304 and a search engine 312. In some embodiments, the requesting device 304 may be provided with one or more search engine interfaces 308 that enable the requesting device 304 to communicate with the search engine 312.

As discussed above, part of maintaining a searchable database 120 may include periodically indexing content stored in the database 120. To this point, such indexing has been described as being performed by a separate indexing engine or by the database interface 116. It should be appreciated that some or all database indexing functions may be performed in the search engine 312. The search engine 312 may correspond to the engine that exposes the database interface 116 and useable query language to a user of the requesting device 304. In some embodiments, the search engine 312 may limit or provide search structure to users of the requesting device 304. The search engine 312 may also be responsible for receiving a search query or search terms and formatting the search query or terms in a format that is understood by the database interface 116.

In some embodiments, the search engine interface 308 may be in the form of a browser, application, or the like. The search engine interface 308 may be natively operating on the requesting device 304 (e.g., as an installed application) or the search engine interface 308 may be made available to the requesting device 304 via a web browser. In particular, the search engine interface 308 may correspond to an HTML page of a web server that interacts with the search engine 312.

When attempting to retrieve content from the database 120, a user may enter one or more search terms into a search term input provided by the search engine interface 308. The one or more search terms entered by the user may be provided to the search engine 312. The search engine 312 may then format and provide the entire search terms as received from the interface 308 to the database interface 116 as a structured or unstructured query consistent with a format understood by the database interface 116. Alternatively, the search engine 312 may modify the search terms to include more or less search terms depending upon an analysis of the search terms received from the user. As an example, the search engine 312 may be configured to determine one or more phonetically-confusable (e.g., similar sounding) terms for the search term(s) entered by the user. These phonetically-confusable terms may be included in a “BUT NOT” operation provided to the database interface 116, meaning that the search engine 312 desires to receive content matching the search term(s) but not content also matching (or more similarly matching) the phonetically-confusable terms included in the “BUT NOT” operation.

The content matching the requested search terms is then provided back to the search engine 312 via the database interface 116 and then is presented to the user via the search engine interface 308. The format of the presentation may vary depending upon user preferences and/or relevance of search results.

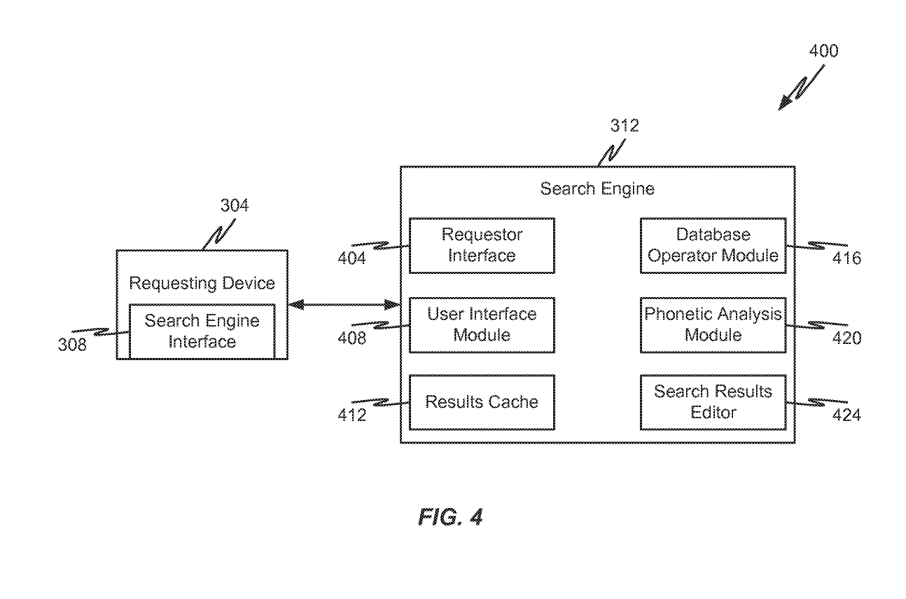

With reference now to FIG. 4, additional details of a search engine 312 will be described in accordance with at least some embodiments of the present disclosure. The components/functionality of the search engine 312, although depicted as being included within the search engine 312, may be implemented in any one or number of other devices depicted in the systems 100, 200, 300. The inclusion of the components in the search engine 312 is for illustrative purposes and is not intended to limit embodiments of the present disclosure. Furthermore, although not depicted, the search engine 312 may include one or many processors and non-transitory computer-readable memory that stores the various modules depicted in FIG. 4. The modules of the search engine 312 may be executed by the processor of the search engine 312. In some embodiments, the search engine 312 may be implemented as one or multiple servers or server blades.

The search engine 312 is depicted as including a requestor interface 404, a user interface module 408, a results cache 412, a database operator module 416, a phonetic analysis module 420, and a search results editor 424. In some embodiments, the requestor interface 404 may correspond to an Application Programming Interface (API) that enables communication between the search engine 312 and an application variant of the search engine interface 308. Alternatively or additionally, the requestor interface 404 may correspond to one or more web pages that are accessible via web-based communications. Specifically, the requestor interface 404 may correspond to one or more HTML documents that enable a user of the requestor device 304 to access the functionality of the search engine 312 via use of a web browser.

The user interface module 408 may correspond to one or more components that control a presentation of the search engine interface 308. For instance, the user interface module 408 may be responsible for presenting a search term entry page to a user of the requesting device 304. Alternatively or additionally, the user interface module 408 may control a presentation of search results. For instance, the user interface module 408 may receive search results from the database interface 116 and prepare/organize the search results in an easy-to-use format. For instance, the user interface module 408 may be responsible for organizing the search results according to their relevance (e.g., more relevant results being placed higher and/or highlighted in the list of search results).

The results cache 412 may correspond to a memory location in the search engine 312 where initial search results received from the database 120 are stored such that they can be organized and/or modified prior to being presented to the user of the requesting device 304. More specifically, the results cache 412 may correspond to cache computer memory that stores all search results before the search results have phonetically-confusable terms removed therefrom. Alternatively or additionally, the results cache 412 may correspond to a location where historical search queries (e.g., what is sent to the database interface 116 by the search engine 312), terms (e.g., what is received from the user of the requesting device 304), and/or results (e.g., what is received back from the database 120 in response to a query) are stored for a predetermined amount of time. This may enable easier reference back to such search queries, terms, and/or results until such time as they are erased from or overwritten in the results cache 412.

The database operator module 416 may be responsible for formatting search queries to the database 120 based on terms and phonetically-confusable terms derived therefrom. Specifically, the database operator module 416 may receive a set of search terms in one format (e.g., a natural language format entry of one or more search terms) and then condition a search query consistent with the received search terms. In some embodiments, the database operator module 416 may include search operators (e.g., AND, NAND, OR, NOR, XOR, and BUT NOT) as logical connectors between search terms. The operators may be placed between search terms, phrases, or phrase portions. The database operator module 416 may be viewed as the interface between the database interface 116 and the search engine 312. In other embodiments, the search operators may be user-defined instead of being inferred by the database operator module 416. Specifically, instead of presenting the user with a natural language input, the user may be provided with Boolean search facilities in which the user is able to devise one or more operators to apply to various search terms. Thus, the user may be responsible for identifying the search terms that are to be excluded based on choice of operators.

The phonetic analysis module 420 may include functionality that allows the search engine 420 to perform an automated phonetic analysis on search terms received from the requesting device 304. In some embodiments, the phonetic analysis module 420 includes or has access to a phonetic dictionary that maps words/terms to phonemes. Said another way, the phonetic analysis module 420 may be able to derive the way a search term or phrase “sounds”. The phonetic analysis module 420 may be configured to provide a mapping between terms and their sounds in one or many different languages. For instance, the phonetic analysis module 420 may be configured to provide a mapping for an English pronunciation of a term or phrase. Thus, the phonetic analysis module 420 may be language-dependent and may also be configured to derive sounds or pronunciations of search terms entered at the requesting device 304. Based on the derived sounds or pronunciation, the phonetic analysis module 420 may also derive or determine phonetically-confusable terms that are not the same as the search term(s), but sound similar to the search term(s). As will be discussed in further detail herein, these phonetically-confusable terms may be located in a phonetics map such that distances between terms and phonetically-confusable terms can be determined in an effort to exclude unwanted or unnecessary results prior to presentation to a user.

The search results editor 424 may work in cooperation with the phonetic analysis module 420 to modify search results. One way that search results can be modified is to remove phonetically-confusable terms from a set of search results. Alternatively or additionally, the search results editor 424 may provide the user interface module 408 with information that describes which search results are considered more relevant than other results, thereby enabling the user interface module 408 to properly organize the results for presentation to a user.

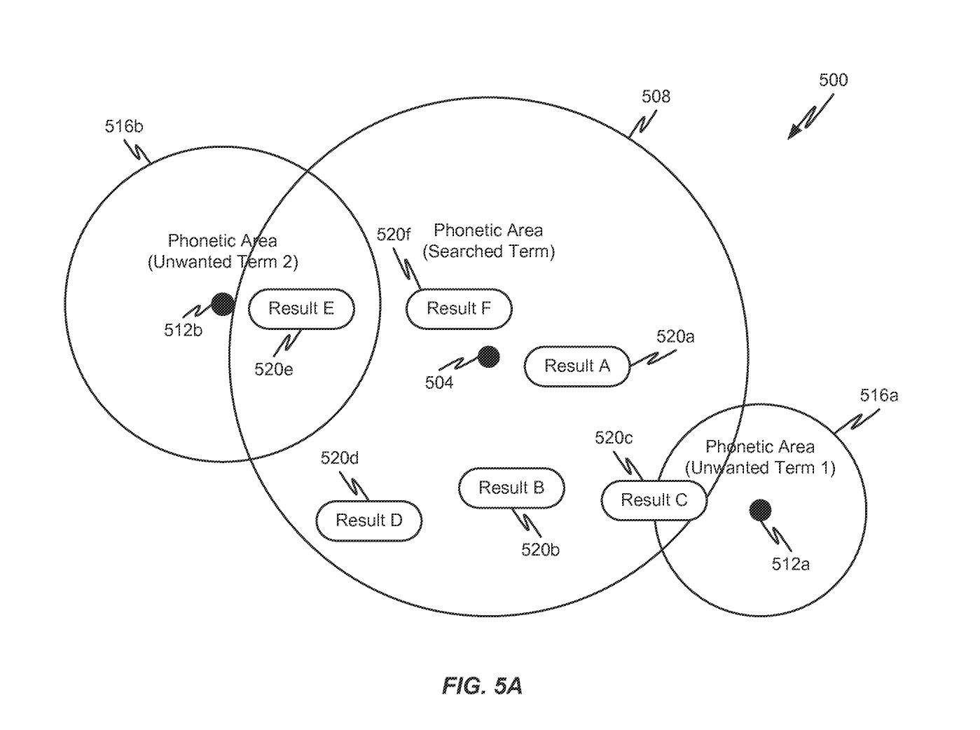

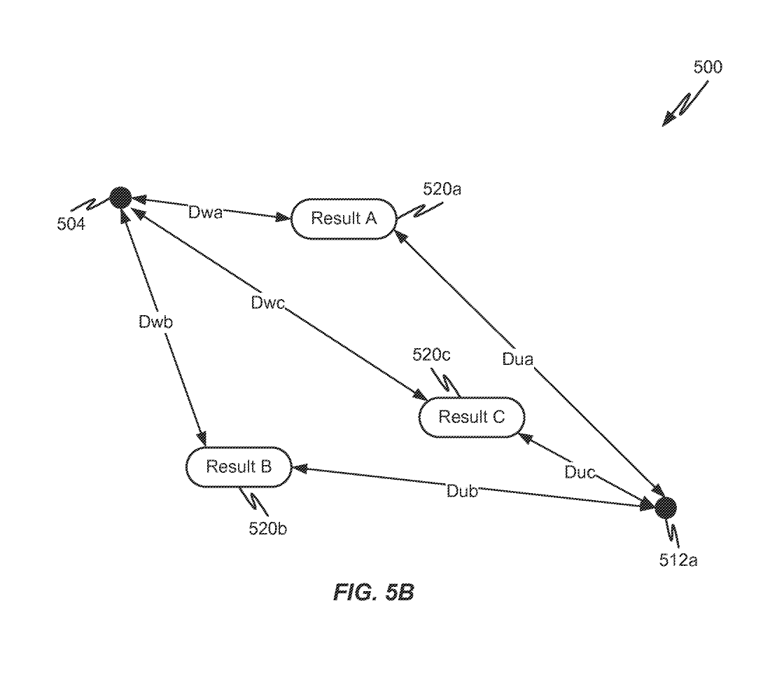

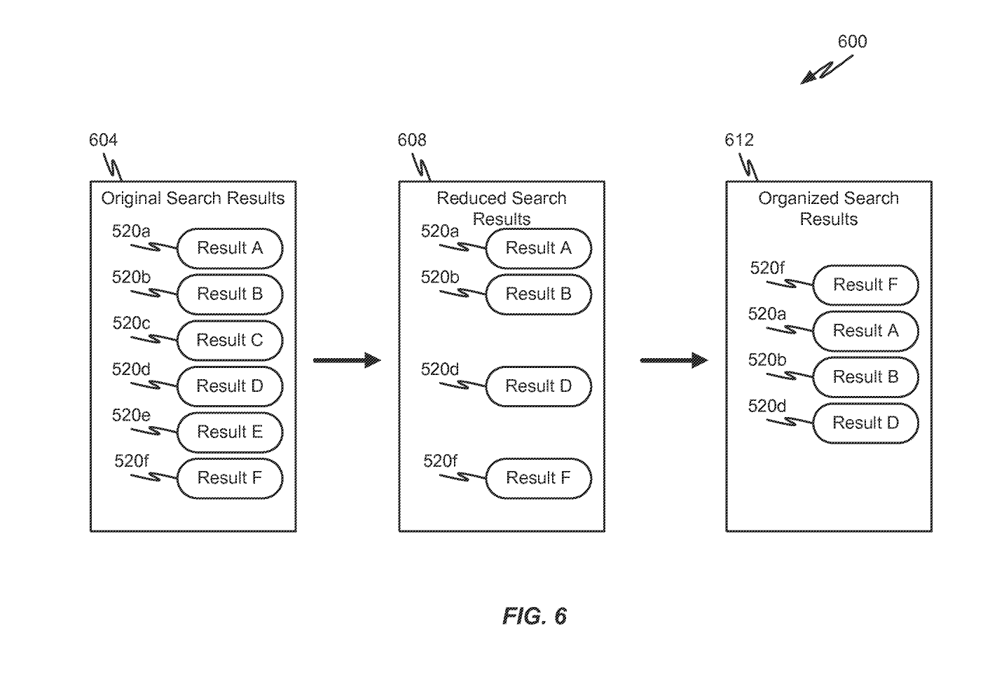

With reference now to FIGS. 5A, 5B, and 6, details of reducing search results by removing phonetically-confusable terms from the search results will be described. As shown in FIG. 6, a flow 600 for reducing original search results 604 to reduced search results 608 and then organizing the reduced search results into organized search results 612 is shown. FIGS. 5A and 5B show two possible automated variations for identifying phonetically-confusable terms for a search term and then removing such phonetically-confusable terms. As used herein, the phrase “phonetically-confusable term” should be understood to include any term, phrase portion, or phrase that does not match the search term but which sounds similar enough to the search term that it gets included in search results with that search term (e.g., because a phonetic search is performed on the search term and the phonetic search returns both terms that include the searched term and phonetically-confusable terms for the search term).

Mechanisms for automating the process for identifying and removing phonetically-confusable terms are described herein as utilizing the concept of phonetic distance. FIGS. 5A and 5B show two possible variations for identifying terms and phonetically-confusable terms on a phonetic map 500, which may represent locations of terms and phonetically-confusable terms in a phonetic space. As discussed herein, the process for calculating or determining a phonetic distance may be dependent on a number of factors (e.g., number of common syllables, sequence of common syllables, number of common phonemes, sequence of common phonemes, number of different syllables, number of different phonemes, etc.). Any number of phonetic distance calculations can be used in accordance with embodiments of the present disclosure. Said another way, embodiments of the present disclosure are not limited to any particular algorithm or method of determining a phonetic distance. One non-limiting example of a process for calculating a phonetic distance is described in U.S. Pat. No. 6,581,034 to Choi et al., the entire contents of which are hereby incorporated herein by reference.

Furthermore, the maps 500 show certain features as being points on the map 500 whereas other features are shown as ovals or circles on the map 500. The illustration of certain features as ovals or circles is for illustrative purposes. It should be appreciated that almost every feature on the map 500 that corresponds to a single term or result should be represented as a point on the map 500. The phonetic distances may correspond to distances between such points and the phonetic areas may correspond to areas produced in the phonetic space based on phonetic distances (e.g., a multiplication of phonetic distances or a multiplication of a phonetic distance by some value).

In a first example, FIG. 5A shows a map 500 with a search term 504 and two phonetically-confusable terms 512a, 512b. A search area 508 is determined for the search term 504. The size and extent of the search area 508 may depend upon a user or administrator's preferences for receiving false positive search results or excluding potentially relevant results. In the depicted embodiment, the search area 508 encompasses and captures a plurality of search results 520a-f. These search results correspond to results for the search term 504 when a phonetic search is carried out for the search term 504 in the database 120. In some embodiments, it may be desirable to exclude some of the results 520a-f in the original search results 604 to arrive at a set of reduced search results 608. FIG. 5A shows a mechanism where phonetically-confusable terms 512a, 512b are defined as points and then unwanted term areas 516a, 516b are respectively computed for those phonetically-confusable search terms 512a, 512b. In some embodiments, the unwanted term areas 516a, 516b may be larger or smaller than the search area 508, again depending upon user and/or administrator preferences.

If a search result 520a-f is situated in both the search area 508 and an unwanted term area 516a or 516b, then that search result is removed from the original search results 604 to arrive at the reduced search results 608. In the depicted example, two results 520c and 520e are found to be within at least one of the unwanted term areas 516a, 516b, which means that those results are removed from the original search results 604 to arrive at the reduced search results 608. As can be appreciated, this removal may occur after search results 520a-f are retrieved from the database 120 or they may be preemptively eliminated from the search results retrieved from the database 120 by using a “BUT NOT” operator. In either scenario, the useful result is achieved where the phonetically-confusable terms are removed from the original search results 604 to obtain the reduced search results 608. These reduced search results 608 may be further organized according to distance from the search term 504, whereby the closest result (e.g., result 520f, then result 520a, then result 520b, then result 520d) are prioritized in ascending or descending order, again depending upon user and/or administrator preferences.

FIG. 5B shows a second alternative for reducing search results obtained from a phonetic search of a database 120. The map 500 of FIG. 5B is similar but reduced as compared to the map 500 of FIG. 5A for ease of discussion. Specifically, only those results lying between the search term 504 and the first unwanted term 512a are depicted. It should be appreciated, however, that this map 500 can easily be extended to show multiple search terms 504 and/or multiple unwanted terms 512. Each result 520a, 520b, 520c may have two phonetic distances calculated in association therewith. A first distance calculated for each result may correspond to a distance between the result 520a, 520b, 520c and the search term 504. In the depicted embodiment, these first distances correspond to Dwa (distance from wanted search term 504 to first result 520a), Dwb (distance from wanted search term 504 to second result 520b), and Dwc (distance from wanted search term 504 to third result 520c). A second distance calculated for each result may correspond to a distance between the result 520a, 520b, 520c and the unwanted or phonetically-confusable search term 512a). In the depicted embodiment, these second distances correspond to Dua (distance from unwanted search term 512a to the first result 520a), Dub (distance from unwanted search term 512a to the second result 520b), and Duc (distance from unwanted search term 512c to the third result 520c).

The first and second distance for each result 520a, 520b, 520c can be compared and/or used to determine whether a result should be included in reduced search results 608 or excluded from reduced search results 608. As one example, if a first distance (e.g., a distance to the wanted search term 504) is smaller than a second distance (e.g., a distance to the unwanted search term 512) for a result, then that result should be included in the reduced search results 608. Conversely, if a first distance is larger than a second distance for a result, then that result should be excluded from the reduced search results 608. Handling the unlikely scenario where the first and second distances are equal may be governed by user and/or administrator preferences for over inclusion or under inclusion of results. In another example, if the first distance is smaller than a predetermined fraction of the second distance for a result (and the predetermined fractional value can be user/administrator configurable), then that result can be included in the reduced search results 608. It should be appreciated embodiments of the present disclosure contemplate including any other mechanism for manipulating the first and second distances of the search results 520 to determine whether the result 520 should be included or excluded from the reduced search results 608.

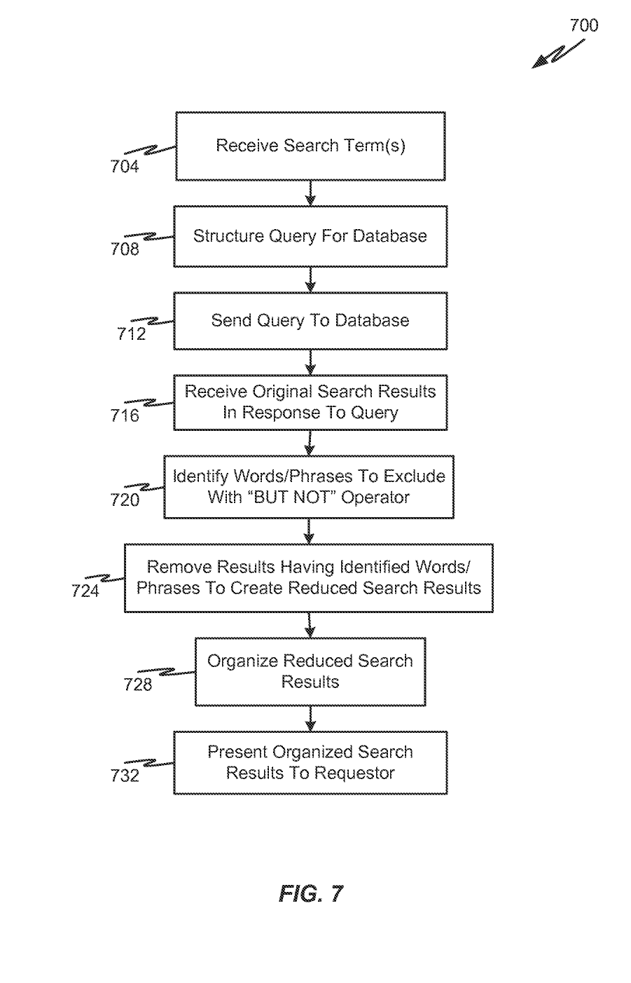

With reference now to FIG. 7, a method for performing a phonetic search will be described in accordance with embodiments of the present disclosure. The method 700 begins when one or more search terms are received from a user (step 704). The search terms may be entered by a user into the search engine interface 308. The search term(s) are used by the search engine 312 to structure or otherwise prepare a query for the database 120 (step 708). In some embodiments, the search term(s) are simply input into the query as they are received, in other embodiments the search term(s) are input into the query with one or more database query operators combining the term(s). Furthermore, the query may be conditioned according to the type of database 120 being queried and the language used to interact therewith.

The query containing the search term(s) is then sent to the database 120 (step 712). Thereafter, original search results 604 are received back from the database 120 (step 716). These original results 604 may be stored in the results cache 412 for further processing before being transmitted back to the user.

In some embodiments, an analysis of the original results 604 may include determining whether the search term(s) have any phonetically-confusable terms associated therewith (step 720). In some embodiments, the phonetically-confusable terms themselves may be identified by determining if any of the search term have already-known phonetically-confusable terms associated therewith (e.g., by referencing a phonetic dictionary and determining whether the term has one or more phonetically-confusable terms associated therewith). In other embodiments, phonetically-confusable terms may be identified by computing phonetic distances or areas (which may be programmatically administered) for the search term and then determining if any non-search-term falls within the computed phonetic distance or area. This particular step is slightly different from the analysis described in connection with FIGS. 5A, 5B, and 6 because this analysis of step 720 is used in connection with identifying unwanted search terms 512, not determining whether results should be included or excluded from the original search results 604. Identification of phonetically-confusable terms may also be done with the assistance of user input or with a computer learning system.

Still other ways of identifying phonetically-confusable terms, such as those used in preparing suggestions for expanding search strings to capture phonetic misspellings, can also be used. An example of such technology used to expand search strings to correct for phonetic misspellings is described in U.S. Pat. No. 7,716,235 to Davallou, the entire contents of which are hereby incorporated herein by reference. This technology is different from the technology of the present disclosure, however, because the phonetically-confusable terms can be identified using the technology of '235 patent to later be used to exclude results from original search results. Thus, instead of expanding a search string as in the '235 patent, the present disclosure identifies phonetically-confusable terms in an attempt to remove search results from a list of original search results 604.

Once phonetically-confusable term(s) are identified for the search term(s), the original results 604 may be reduced to a set of reduced search results 608 as described in connection with FIGS. 5A, 5B, and 6 (step 724). Thereafter, the reduced search results 608 may be organized into organized search results 612 (step 728) and then presented to the search results requestor (step 732).

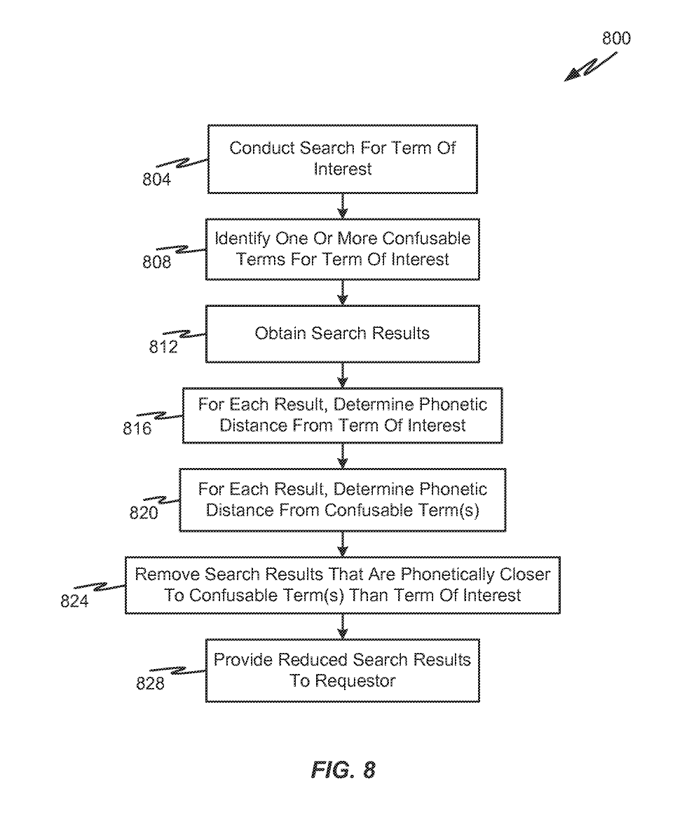

With reference now to FIG. 8, a method of refining a phonetic search will be described in accordance with embodiments of the present disclosure. The method 800 begins when a phonetic search is performed on a database 120 for one or more terms of interest (step 804). The method continues with the identification of one or more phonetically-confusable terms associated with each term of interest included in the search (step 808). The process of step 808 may be similar or identical to the process described in connection with step 720.

Before, simultaneous with, or following step 808, the method 800 continues when original search results 604 are obtained at the search engine 312 (step 812). For each result, phonetic distances are calculated between the result and the term of interest (step 816). This distance may be referred to as a first calculated phonetic distance for the result. For each result, phonetic distances are also calculated between the result and each of the phonetically-confusable terms identified in step 812 (step 820). This distance for each result may be referred to as a second calculated phonetic distance for the result.

Based on the phonetic distances calculated for each result, the original search results 604 are reduced to a set of reduced results 608 (step 824). As one example, each result that is phonetically closer to one or more confusable terms than to a term of interest is removed. Other algorithms and mechanisms may be used to remove results from the original search results 604.

Once reduced, the search results 608 may be provided to the requestor or they may be organized according to relevance prior to being provided to the requestor (step 828). The results may be provided to the requestor via a user interface of a communication device 108 operated by the user (e.g., via a search engine interface 308).

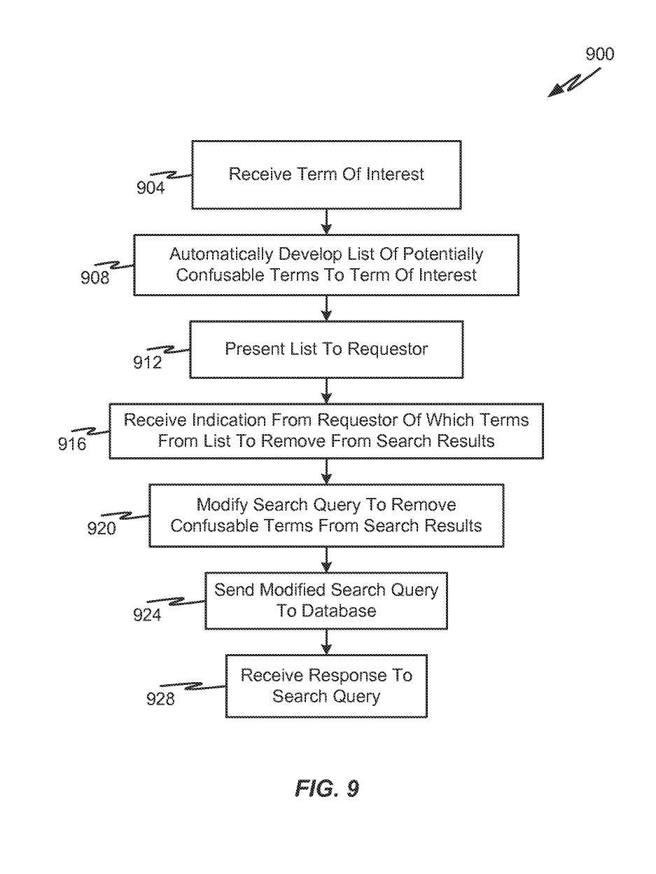

With reference now to FIG. 9, a method of modifying a search query prior to sending the search query to a database 120 will be described in accordance with embodiments of the present disclosure. The method 900 begins with the receipt of search terms, which may also be referred to as terms of interest (step 904). Upon receiving the terms of interest, the search engine 312 may automatically develop a list of potentially phonetically-confusable terms for each term of interest (step 908). The identification of potential phonetically-confusable terms may be done in a similar fashion to steps 720 or 808. In some embodiments, the potential phonetically-confusable terms may be automatically used to reduce the search terms and/or adjust the query being sent to the database 120. In other embodiments, user input may be requested by providing a list of the potentially phonetically-confusable terms to the user that entered the search to let the user decide whether to exclude such phonetically-confusable terms from the search query (step 912).

If the list is presented to the user, then the method will wait to receive an indication from the user of which terms from the list to remove from the search query (step 916). In some embodiments, the user may provide standing instructions that indicate only certain types of phonetically-confusable terms should be excluded (e.g., terms that are within a predetermined phonetic distance of a search term). Alternatively, the user may require that user input is received prior to modifying the search query.

Following completion of steps 912 and 912 or the optional skipping of such steps due to a completely automated implementation, the method 900 continues by modifying the search query to remove the phonetically-confusable terms from the search results that will be received back from the database 120 (step 920). In some embodiments, this is accomplished by modifying the search query to include one or more “BUT NOT” operators for each of the phonetically-confusable terms.

The modified search query is sent to the database 120 (step 924) according to the language used between the database 120 and the database interface 116. Thereafter, results to the search query are received at the database interface 116 and provided to the search engine 312 (step 928). These results can then be provided directly to the requestor or modified according to relevance.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor (GPU or CPU) or logic circuits programmed with the instructions to perform the methods (FPGA). These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

While illustrative embodiments of the disclosure have been described in detail herein, it is to be understood that the inventive concepts may be otherwise variously embodied and employed, and that the appended claims are intended to be construed to include such variations, except as limited by the prior art.

What is claimed is:

1. A phonetic search engine, comprising:
a requestor interface configured to receive one or more search terms for a phonetic search to be performed on a database containing phonetically-searchable content;
a database operator module configured to format a database query that includes at least some of the one or more search terms received at the requestor interface; and
a phonetic analysis module configured to perform at least one of the following to exclude phonetically-confusable terms associated with the one or more search terms from search results provided to a user: (i) modify the database query prior to the database query being sent to the database and (ii) modify original search results received from the database to obtain reduced search results.

2. The phonetic search engine of claim 1, wherein the phonetic analysis module modifies the database query prior to the database query being sent to the database.

3. The phonetic search engine of claim 2, wherein the database query comprises a “BUT NOT” operator associated with the phonetically-confusable terms.

4. The phonetic search engine of claim 1, wherein the phonetic analysis module modifies the original search results received from the database.

5. The phonetic search engine of claim 4, wherein the phonetic analysis module identifies results to remove from the original search results by performing the following:
determining a first phonetic distance between a result and a search term in the one or more search terms;
determining a second phonetic distance between the result and a phonetically-confusable term associated with the search term; and
based on a comparison of the first and second phonetic distances, determining whether the result is to be included or excluded from the reduced search results.

6. The phonetic search engine of claim 5, wherein results having their second phonetic distance less than their first phonetic distance are excluded from the reduced search results.

7. The phonetic search engine of claim 4, wherein the phonetic analysis module identifies results to remove from the original search results by performing the following:
determining a search result area for a search term in the one or more search terms;
determining an unwanted search result area for a phonetically-confusable term associated with the search term; and
excluding search results found in both the search result area and the unwanted search result area from the reduced search results.

8. The phonetic search engine of claim 1, wherein the phonetically-confusable terms associated with the one or more search terms are removed from the search results provided to the user in a set of ordered search results that are prioritized based on phonetic distance from each result and the one or more search terms.

9. The phonetic search engine of claim 1, wherein the phonetically-searchable content comprises at least one of audio and video content from a communication session between two or more session participants.

10. A system, comprising:
one or more servers configured to provide an interface between a user communication device and a database that contains phonetically-searchable content, the one or more servers including a search engine that is configured to receive on more search terms for a phonetic search to be performed on the database and a phonetic analysis module configured to exclude phonetically-confusable terms associated with the one or more search terms from search results provided to the user communication device by at least one of: (i) modifying a database query prior to the database query being sent to the database and (ii) modifying original search results received from the database to obtain reduced search results that are provided to the user communication device.

11. The system of claim 10, wherein the phonetic analysis module modifies the database query prior to the database query being sent to the database.

12. The system of claim 11, wherein the database query comprises a “BUT NOT” operator associated with the phonetically-confusable terms.

13. The system of claim 10, wherein the phonetic analysis module modifies the original search results received from the database.

14. The system of claim 13, wherein the phonetic analysis module identifies results to remove from the original search results by performing the following:
determining a first phonetic distance between a result and a search term in the one or more search terms;
determining a second phonetic distance between the result and a phonetically-confusable term associated with the search term; and
based on a comparison of the first and second phonetic distances, determining whether the result is to be included or excluded from the reduced search results.

15. The system of claim 14, wherein results having their second phonetic distance less than their first phonetic distance are excluded from the reduced search results.

16. The system of claim 10, wherein the phonetically-searchable content comprises at least one of audio and video content from a communication session between two or more session participants.

17. A method of performing phonetic searches, the method comprising:
receiving one or more search terms for a phonetic search to be performed on a database containing phonetically-searchable content;
formatting a database query that includes at least some of the received one or more search terms; and
performing at least one of the following to exclude phonetically-confusable terms associated with the one or more search terms from search results provided to a user:
(i) modifying the database query prior to the database query being sent to the database; and
(ii) modifying original search results received from the database to obtain reduced search results.

18. The method of claim 17, further comprising:
including a “BUT NOT” operator associated with the phonetically-confusable terms in the database query.

19. The method of claim 17, further comprising:
determining a first phonetic distance between a result and a search term in the one or more search terms;
determining a second phonetic distance between the result and a phonetically-confusable term associated with the search term; and
based on a comparison of the first and second phonetic distances, determining whether the result is to be included or excluded from the reduced search results.

20. The method of claim 17, wherein the phonetically-searchable content comprises at least one of audio and video content from a communication session between two or more session participants.
